(19) United States
(12) Patent Application Publication
(10) Pub. No.: US 2024/0364066 A1
(43) Pub. Date: Oct. 31, 2024

(54) CONNECTOR MANUFACTURING APPARATUS

(71) Applicant: Yazaki Corporation, Tokyo (JP)

(72) Inventors: Naoki KOBAYASHI, Makinohara-shi (JP); Masaki Tanaka, Makinohara-shi (JP); Jun Ishikawa, Tokyo (JP)

(21) Appl. No.: 18/622,115

(22) Filed: Mar. 29, 2024

(30) Foreign Application Priority Data
Apr. 26, 2023 (JP) 2023-072379

(51) Int. Cl. H01R 43/20

(52) U.S. Cl. CPC H01R 43/20; H01R 2201/26

(57) ABSTRACT

A connector manufacturing apparatus for manufacturing a connector that includes a connected body including tab terminals and a housing including a housing body in a tubular shape containing the connected body and terminal-containing portions provided in the housing body to contain the respective tab terminals, wherein the connector manufacturing apparatus comprises a press-fit jig, wherein the tab terminals include first tab terminals that include latch protrusions capable of biting into inner surfaces of the terminal-containing portions to latch to the terminal-containing portions and second tab terminals that do not include the latch protrusions, the connected body is provided with a jig contact surface on an end face on an opposite side from the first tab terminals, the jig contact surface being formed for the press-fit jig to come into contact therewith.

### TECHNICAL FIELD

The present invention relates to a connector manufacturing apparatus.

### BACKGROUND

Automobiles are equipped with a wide variety of electronic devices, and wire harnesses are routed to transmit power, control signals, and the like to the electronic devices. A wire harness is equipped with multiple electric wires and connectors, and is connected to an electronic device or another wire harness by fitting this connector to the connector of the electronic device or the another wire harness (for example, see Patent Document 1).

Patent Document 1 discloses a ground joint connector including a ground joint terminal and a connector housing.

The ground joint terminal includes a joint terminal portion obtained by integrally forming, into a comb-tooth shape, multiple connection terminals in a tongue shape, an arm portion extending from the joint terminal portion, and a ground terminal portion provided at the tip of the arm portion and connected to the ground, and the ground joint terminal is integrally formed of a single metal plate.

The joint terminal portion includes a first joint terminal portion a side edge of which the arm portion extends and a second joint terminal portion formed parallel to the first joint terminal portion from a fold-back portion on the rear end side of the first joint terminal portion.

The connector housing is a resin molded product, and includes a joint terminal-containing portion configured to contain the joint terminal portion and a connector mating portion in which a connector housing of a mating side fits.

The earth joint connector explained above is assembled by pressing in the joint terminal portion and causing the joint terminal portion to be contained in the joint terminal-containing portion.

### RELATED ART

### Patent Document

Patent Document 1: JP2011-065931 (A)

### SUMMARY OF THE INVENTION

### Problem to be Solved by the Invention

However, since the conventional earth joint connector is assembled by pressing in the joint terminal portion and causing the joint terminal portion to be contained in the joint terminal-containing portion, the conventional earth joint connector has a problem in that the first joint terminal portion (tab terminal) and the second joint terminal portion (tab terminal) may be deformed due to the load during pressing-fit.

It is an object of the present invention to provide a connector manufacturing apparatus that alleviates deformation of the tab terminals.

### Solution to Problem

In order to solve the above problems and achieve the object, according to an aspect of the present invention, a connector manufacturing apparatus for manufacturing a connector that includes: a connected body including tab terminals; and a housing including a housing body in a tubular shape containing the connected body and terminal-containing portions provided in the housing body to contain the respective tab terminals, wherein the connector manufacturing apparatus comprises a press-fit jig for pressing the connected body into the housing to contain the tab terminals in the terminal-containing portions, wherein the tab terminals include: first tab terminals that include latch protrusions capable of biting into inner surfaces of the terminal-containing portions to latch to the terminal-containing portions; and second tab terminals that do not include the latch protrusions, the connected body is provided with a jig contact surface on an end face on an opposite side from the first tab terminals, the jig contact surface being formed for the press-fit jig to come into contact therewith.

### Advantageous Effects of the Invention

According to an aspect of the present invention, deformation of the tab terminals can be alleviated.

### BRIEF DESCRIPTION OF THE DRAWINGS

FIG. 1 is a perspective view illustrating a connector constituting a connector manufacturing apparatus according to an embodiment of the present invention.

FIG. 2 is a plan view of the connector as seen from the upper side.

FIG. 3 is an exploded perspective view illustrating the connector.

FIG. 4 is a plan view for explaining a procedure of assembling the connector, and is a view illustrating a busbar constituting the connector being brought closer to the housing.

FIG. 5 is a view for explaining a post-process of FIG. 4.

FIG. 6 is a view for explaining a post-process of FIG. 5, and is a plan view illustrating the connector in an assembled state.

FIG. 7 is a plan view illustrating a modified example of the connector.

### DETAILED DESCRIPTION OF THE EXEMPLARY EMBODIMENT

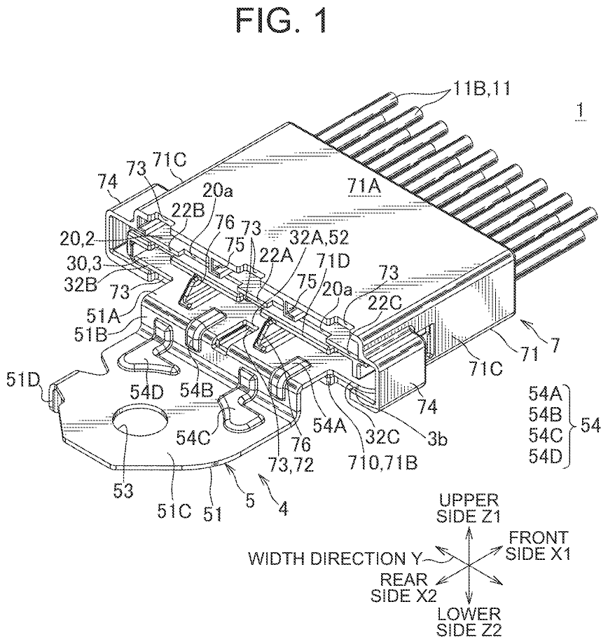

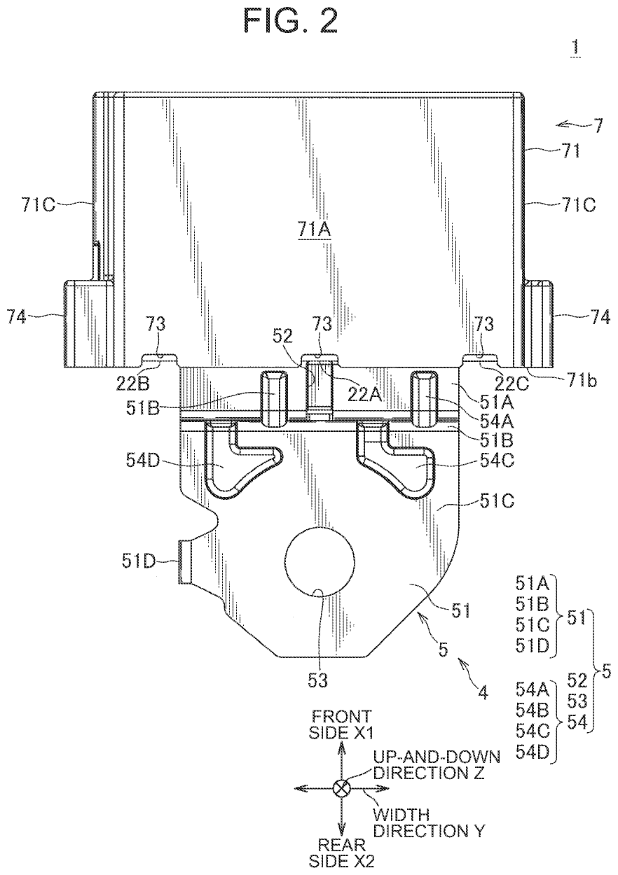

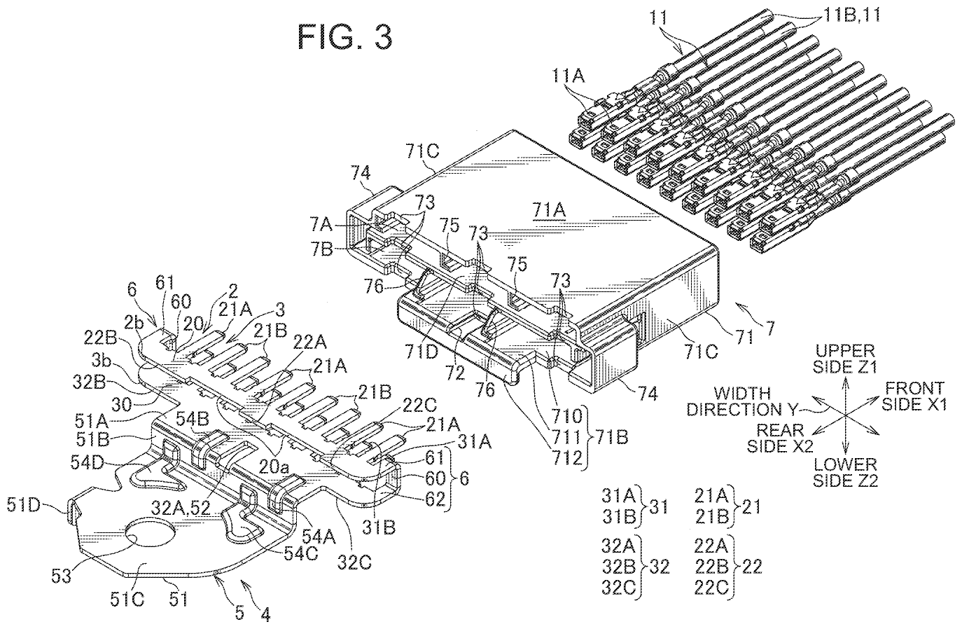

Hereinafter, an embodiment of the present invention is described with reference to FIGS. 1 to 6. FIG. 1 is a perspective view illustrating a connector 1 constituting a connector manufacturing apparatus 10 according to an embodiment of the present invention. FIG. 2 is a plan view of the connector 1 as seen from an upper side Z1. FIG. 3 is an exploded perspective view illustrating the connector 1.

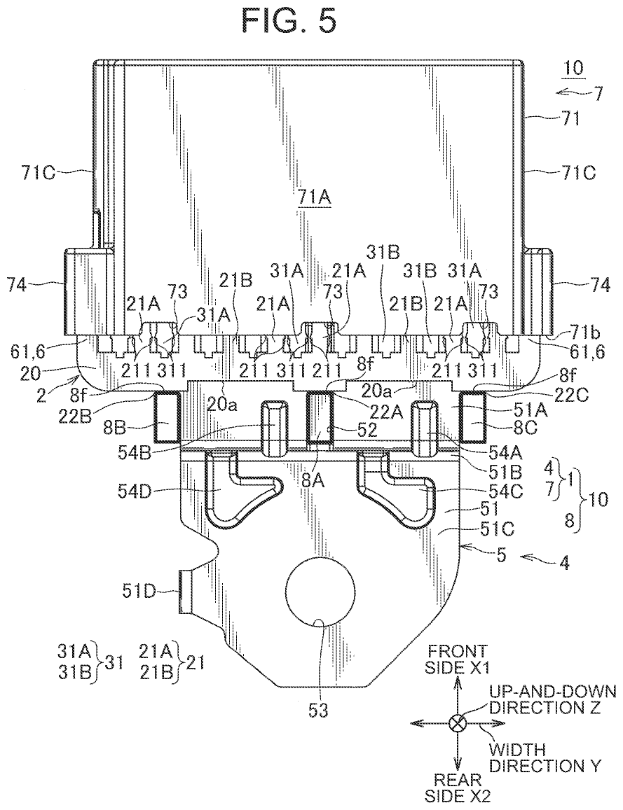

As illustrated in FIGS. 1 and 5, the connector manufacturing apparatus 10 according to an embodiment of the present invention is to manufacture the connector 1, and includes a press-fit jig 8 (as illustrated in FIG. 5) for pressing a busbar 4 having multiple tab terminals 21, 31 (illustrated in FIG. 5) into the housing 7 to cause the respective tab terminals 21, 31 to be contained in respective terminal-containing portions (not illustrated).

The connector 1 is manufactured with the press-fit jig 8 explained later, and as illustrated in FIGS. 1 to 3, and includes the busbar 4 including the multiple tab terminals 21, 31 (illustrated in FIG. 3), and the housing 7 including the multiple terminal-containing portions containing the respective multiple tab terminals 21, 31. As illustrated in FIG. 3, in the connector 1, terminal-attached electric wires 11 are connected to the respective multiple tab terminals 21, 31, which are in turn fixed to a vehicle body panel, not illustrated, so that electric currents passing through the terminal-attached electric wires 11 are grounded. Each of the terminal-attached electric wires 11 includes a terminal metal fitting (which may be hereinafter referred to as a female terminal 11A) of a female type connected to the respective tab terminals 21, 31 and an electric wire 11B connected to the female terminal 11A.

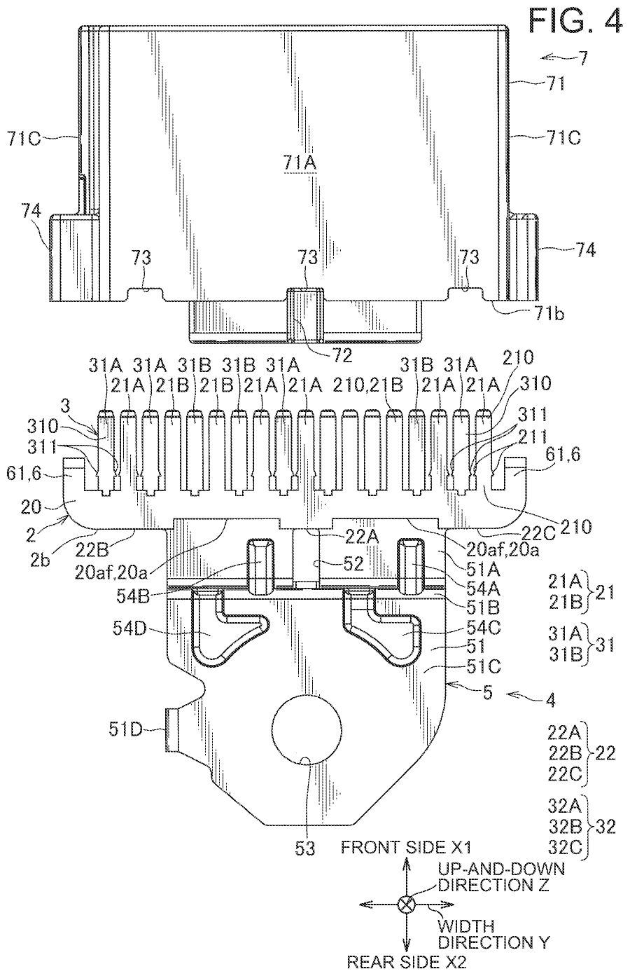

As illustrated in FIGS. 3, 4, the busbar 4 includes an upper side connected body 2, a lower side connected body 3 (illustrated in FIG. 3), a vehicle body fixation portion 5 provided continuously to the lower side connected body 3 and fixed to the vehicle body panel, and a pair of coupling portions 6, 6 configured to couple the upper side connected body 2 and the lower side connected body 3.

In the present embodiment, an X direction (front-and-back direction), a Y direction (width direction, a direction in which the tab terminals 21, 31 are arranged), and a Z direction (up-and-down direction) are direction perpendicular to each other. A direction in which the tab terminals 21, 31 extend may be referred to as “front side (X1 direction)”, and a direction opposite thereto may be referred to as a “rear side (X2 direction)”. A direction in which the upper side connected body 2 and the lower side connected body 3 oppose each other may be referred to as an “up-and-down direction (Z direction)”, one side in the Z direction (side of the upper side connected body 2) may be referred to as an “upper side (Z1 direction)”, and the other side in the Z direction (side of the lower side connected body 3) may be referred to as a “lower side (Z2 direction)”.

As illustrated in FIGS. 3, 4, the upper side connected body 2 includes an upper side base portion 20 (base portion) in a rectangular shape extending in the width direction Y, upper side tab terminals 21 (tab terminals) extending from the upper side base portion 20 to the front side X1, and upper side jig contact surfaces 22 (jig contact surfaces) provided on the upper side base portion 20 to receive contact of the press-fit jig 8. The upper side tab terminal 21 includes an upper side first tab terminal 21A (first tab terminal) and an upper side second tab terminal 21B (second tab terminal).

As illustrated in FIG. 4, three (multiple) upper side jig contact surfaces 22 are provided. The three upper side jig contact surfaces 22 are provided at a central portion and both end portions, in the width direction Y, on a rear end face 2b of the upper side connected body 2, and are situated on the rear side X2 of upper side first tab terminals 21A explained later. The upper side jig contact surfaces 22 are constituted by flat end faces extending in the width direction Y and the up-and-down direction Z. Hereinafter, the upper side jig contact surface 22 provided on the central portion in the width direction Y may be referred to as an “upper side central contact surface 22A (22)”, and the upper side jig contact surfaces 22 provided on both end portions in the width direction Y may be referred to as “upper side both-end contact surfaces 22B, 22C (22)”. The upper side central contact surface 22A and the pair of upper side both-end contact surfaces 22B, 22C are situated at the same position in the front-and-back direction X and the up-and-down direction Z. Specifically, the upper side central contact surface 22A and the pair of upper side both-end contact surfaces 22B, 22C are provided on the same plane.

As illustrated in FIG. 4, in the width direction Y, the upper side base portion 20 has a pair of notch portions 20a, 20a at positions adjacent to the upper side jig contact surfaces 22, the pair of notch portions 20a, 20a being formed by cutting off the rear edge (at the same position as the rear end face 2b) of the upper side base portion 20. The notch portions 20a are situated on the rear side X2 of the upper side second tab terminals 21B explained later, and front end faces 20af of the notch portions 20a are situated on the front side X1 with respect to the upper side jig contact surface 22. Accordingly, the jig contact surfaces 22A, 22B, 22C are provided protruding with respect to the notch portions 20a, so that the jig contact surfaces 22A, 22B, 22C become distinguishable from other parts.

As illustrated in FIG. 4, five (multiple) upper side first tab terminals 21A are provided, and four (multiple) upper side second tab terminals 21B. Specifically, on the upper side base portion 20, two upper side first tab terminals 21A are provided in the central portion in the width direction Y, one upper side first tab terminal 21A is provided in one of the end portions in the width direction Y, and two upper side first tab terminals 21A are provided in the other of the end portions. In other words, the upper side first tab terminals 21A are provided in the central portion and both end portions in the width direction Y of the upper side base portion 20. The four upper side second tab terminals 21B are provided such that two upper side second tab terminals 21B are provided between the upper side first tab terminal 21A situated in the central portion and the upper side first tab terminal 21A situated in each of the both end portions of the upper side base portion 20.

As illustrated in FIG. 4, the upper side first tab terminal 21A includes an upper side tab terminal body 210 in a tongue shape extending to the front side X1 and a pair of upper side latch protrusions 211, 211 provided on the upper side tab terminal body 210 to be able to latch to the inner surface of the terminal-containing portion explained later.

As illustrated in FIG. 4, the upper side latch protrusions 211, 211 constituting the pair are provided, on the upper side tab terminal body 210, at positions distant by a predetermined distance from the upper side base portion 20 toward the front side X1 to extend to either side in the width direction Y. The upper side latch protrusions 211 extend on the same plane as the upper side tab terminal body 210, and are formed in a triangular shape as seen from the upper side Z1.

Also, the width size of the upper side first tab terminal 21A at a position where the pair of upper side latch protrusions 211, 211 is provided is formed to be larger than the width size of each of the terminal-containing portions explained later. The pair of upper side latch protrusions 211, 211 of each of the upper side first tab terminals 21A bites into the inner surface of the terminal-containing portion to latch to the terminal-containing portion.

The upper side second tab terminal 21B is configured to include an upper side tab terminal body 210 in a tongue shape extending to the front side X1. The upper side second tab terminal 21B is not provided with the pair of upper side latch protrusions 211, 211 capable of latching to the inner surface of the terminal-containing portion.

As illustrated in FIGS. 3, 4, the lower side connected body 3 includes a lower side base portion 30 (base portion, illustrated in FIG. 3) in a rectangular shape extending in the width direction Y, lower side tab terminals 31 (tab terminals) extending from the lower side base portion 30 to the front side X1, and a lower side jig contact surface 32 (jig contact surface, illustrated in FIG. 3) provided on the lower side base portion 30 to receive contact of the press-fit jig 8. The lower side tab terminal 31 includes a lower side first tab terminal 31A (first tab terminal) and a lower side second tab terminal 31B (second tab terminal).

As illustrated in FIG. 3, three (multiple) lower side jig contact surfaces 32 are provided. The three lower side jig contact surfaces 32 provided in the central portion and both end portions in the width direction Y of the rear end face 3b of the lower side connected body 3. The lower side jig contact surfaces 32 are constituted by flat end faces extending in the width direction Y and the up-and-down direction Z. Hereinafter, the lower side jig contact surface 32 situated in the central portion in the width direction Y may be referred to as a “lower side central contact surface 32A (32)”, and the lower side jig contact surfaces 32 situated in the both end portions in the width direction Y may be referred to as “lower side both-end contact surfaces 32B, 32C (32)”. The lower side central contact surface 32A and the pair of lower side both-end contact surfaces 32B, 32C are situated at the same position in the front-and-back direction X and the up-and-down direction Z. Specifically, the lower side central contact surface 32A and the pair of lower side both-end contact surfaces 32B, 32C are provided on the same plane.

Furthermore, the lower side central contact surface 32A and the pair of lower side both-end contact surfaces 32B, 32C and the upper side central contact surface 22A and the pair of upper side both-end contact surfaces 22B, 22C are situated on the same plane.

As illustrated in FIG. 4, four (multiple) lower side first tab terminals 31A are provided, and five (multiple) lower side second tab terminals 31B are provided. Specifically, on the lower side base portion 30, one lower side first tab terminal 31A is provided in the central portion, in the width direction Y, of the lower side base portion 30, two lower side first tab terminals 31A are provided in one of the end portions in the width direction Y, and one lower side first tab terminal 31A is provided in the other of the end portions. In other words, the lower side first tab terminals 31A are provided in the central portion and both end portions in the width direction Y of the lower side base portion 30. The five lower side second tab terminals 31B are provided such that two lower side second tab terminals 31B are provided between the lower side first tab terminal 31A situated in the central portion, in the width direction Y, of the lower side base portion 30 and two lower side first tab terminals 31A situated in one of the end portions in the width direction Y, and three lower side second tab terminals 31B are provided between the lower side first tab terminal 31A situated in the central portion, in the width direction Y, of the lower side base portion 30 and one lower side first tab terminal 31A provided in the other of the end portions in the width direction Y.

As illustrated in FIG. 4, the lower side first tab terminal 31A includes a lower side tab terminal body 310 in a tongue shape extending to the front side X1 and a pair of lower side latch protrusions 311, 311 provided on the lower side tab terminal body 310 to be able to latch to the inner surface of the terminal-containing portion explained later.

As illustrated in FIG. 4, the lower side latch protrusions 311, 311 constituting the pair are provided, on the lower side tab terminal body 310, at positions distant by a predetermined distance from the lower side base portion 30 toward the front side X1 to extend to either side in the width direction Y. The lower side latch protrusions 311 extend on the same plane as the u lower side tab terminal body 310, and are formed in a triangular shape as seen from the upper side Z1.

Also, the width size of the lower side first tab terminal 31A at a position where the pair of lower side latch protrusions 311, 311 is provided is formed to be larger than the width size of each of the terminal-containing portions explained later. The pair of lower side latch protrusions 311, 311 of each of the lower side first tab terminals 31A bites into the inner surface of the terminal-containing portion to latch to the terminal-containing portion.

The lower side second tab terminal 31B is configured to include a lower side tab terminal body 310 in a tongue shape extending to the front side X1. The lower side second tab terminal 31B is not provided with the pair of lower side latch protrusions 311, 311 capable of latching to the inner surface of the terminal-containing portion.

As illustrated in FIGS. 1, 4, the vehicle body fixation portion 5 includes a vehicle body fixation portion main body 51 continuous to the rear side X2 of the lower side connected body 3, a busbar side jig insertion hole 52 (hole portion) provided in the vehicle body fixation portion main body 51 and including the lower side central contact surface 32A to allow the press-fit jig 8 to be inserted therethrough, a bolt insertion hole 53 allowing a stud bolt (not illustrated) protruding from the vehicle body panel to be inserted therethrough, and multiple (four) embossed portions 54 provided on the vehicle body fixation portion main body 51.

As illustrated in FIG. 1, the vehicle body fixation portion main body 51 includes a first plate-shaped portion 51A continuous to the rear side X2 of the lower side connected body 3, a second plate-shaped portion 51B continuous to the rear side X2 of the first plate-shaped portion 51A and bent to extend to the lower side Z2, a third plate-shaped portion 51C continuous to the lower end of the second plate-shaped portion 51B and bent to extend to the rear side X2, and a fourth plate-shaped portion 51D bent from the third plate-shaped portion 51C and extending to the lower side Z2.

As illustrated in FIG. 4, the first plate-shaped portion 51A is formed in a rectangular plate shape, and is situated in the central portion, in the width direction Y, of the lower side base portion 30 of the lower side connected body 3. The first plate-shaped portion 51A is formed such that the size of the first plate-shaped portion 51A in the width direction Y is larger than the pair of notch portions 20a, 20a, and as seen from the upper side Z1, the first plate-shaped portion 51A is provided at a position of the upper side connected body 2 that includes the pair of notch portions 20a, 20a. The first plate-shaped portion 51A is provided on the same plane as the lower side base portion 30 of the lower side connected body 3.

As illustrated in FIG. 1, the third plate-shaped portion 51C is provided opposite to the first plate-shaped portion 51A, and is provided opposite to the vehicle body panel.

As illustrated in FIG. 1, the fourth plate-shaped portion 51D is provided continuous to one side, in the width direction Y, of the third plate-shaped portion 51C, and is provided to be bent from the third plate-shaped portion 51C and extend to the lower side Z2. This fourth plate-shaped portion 51D is configured to be inserted into a slit (not illustrated) provided in the vehicle body panel.

As illustrated in FIGS. 1, 4, as seen from the upper side Z1, the busbar side jig insertion hole 52 is made of a hole portion in a rectangular shape extending in the front-and-back direction X. The busbar side jig insertion hole 52 is situated in the central portion of the vehicle body fixation portion main body 51 in the width direction Y, and is provided continuous from the first plate-shaped portion 51A to the second plate-shaped portion 51B.

As illustrated in FIG. 1, the lower side central contact surface 32A is provided on an end face (front end face) on the front side X1 of the busbar side jig insertion hole 52. The busbar side jig insertion hole 52 is configured such that, when the press-fit jig 8 explained later is inserted into the busbar side jig insertion hole 52, the lower side central contact surface 32A and the pressure surface 8f of the press-fit jig 8 come into contact with each other.

The bolt insertion hole 53 is provided in the central portion of the third plate-shaped portion 51C to penetrate the third plate-shaped portion 51C, and is configured to allow a stud bolt (not illustrated) protruding from the vehicle body panel to be inserted therethrough.

As illustrated in FIGS. 3, 4, multiple (four) embossed portions 54 include a pair of first embossed portions 54A, 54B and a pair of second embossed portions 54C, 54D.

The first embossed portions 54A, 54B, constituting the pair, are provided on either side of the busbar side jig insertion hole 52. The first embossed portions 54A, 54B are arranged in a rectangular shape as seen from the upper side Z1, and are provided continuously from the first plate-shaped portion 51A to the second plate-shaped portion 51B. Hereinafter, one of the first embossed portions 54A, 54B constituting the pair may be referred to as “one-side first embossed portion 54A”, and the other of the first embossed portions 54A, 54B constituting the pair may be referred to as “another-side first embossed portion 54B”.

The second embossed portions 54C, 54D constituting the pair are arranged side by side in the width direction Y. The second embossed portion 54C on one side is provided between the one-side first embossed portion 54A and the busbar side jig insertion hole 52. The second embossed portion 54D on the other side is provided on an opposite side of the another side first embossed portion 54B from the busbar side jig insertion hole 52.

As illustrated in FIG. 3, the coupling portions 6, 6 constituting the pair are provided in both end portions, in the width direction Y, of the upper side connected body 2 and the lower side connected body 3. Each of the coupling portions 6 is formed in a substantially C-shape that includes a coupling portion main body 60 extending in the up-and-down direction Z, an upper side continuous plate 61 bent at a boundary position with the coupling portion main body 60 to extend to the rear side X2, and a lower side continuous plate 62 bent at a boundary position with the coupling portion main body 60 to extend to the rear side. The upper side continuous plate 61 is provided continuous to the upper side base portion 20 of the upper side connected body 2, and the lower side continuous plate 62 is provided continuous to the lower side base portion 30 of the lower side connected body 3.

In order to manufacture the busbar 4, as illustrated in FIG. 3, after a metal plate has been embossed and punched to form a punched member (not illustrated), the boundary position between the coupling portion main body 60 and the upper side continuous plate 61 of the coupling portion 6 is bent, and the boundary position between the coupling portion main body 60 and the lower side continuous plate 62 of the coupling portion 6 is bent, so that the upper side connected body 2 and the lower side connected body 3 oppose each other. Furthermore, the boundary position between the first plate-shaped portion 51A and the second plate-shaped portion 51B is bent, and the boundary position between the second plate-shaped portion 51B and the third plate-shaped portion 51C is bent, so that the first plate-shaped portion 51A and the third plate-shaped portion 51C oppose each other. Thus, the busbar 4 is manufactured. When the busbar 4 is seen from the upper side Z1, the upper side tab terminals 21 of the upper side connected body 2 and the lower side tab terminals 31 of the lower side connected body 3 are arranged alternately in the width direction Y.

The housing 7 is made of, for example, insulating resin. As illustrated in FIG. 3, the housing 7 includes a housing body 71 formed in a square tube shape with as the front-and-back direction X being the axis, a housing side jig insertion hole 72 provided in the housing body 71 to overlap with the busbar side jig insertion hole 52 to be in communication therewith, housing side notch portions 73 (press-in amount measurement windows) through which the busbar 4 is inserted into the inside of the housing body 71, and a pair of C-shaped containing portions 74, 74 provided to protrude in a C-shape on either side of the housing body 71 in the width direction Y to contain the pair of coupling portions 6, 6 of the busbar 4.

As illustrated in FIG. 3, the housing body 71 includes an upper wall 71A, a lower wall 71B, and a pair of side walls 71C, 71C, and is configured in square tube shape. The internal space of the housing body 71 is formed to be separated by an up-and-down partition wall 71D into an upper side connected body containing portion 7A for containing the upper side connected body 2 and a lower side connected body containing portion 7B for containing the lower side connected body 3.

Each of the upper side connected body containing portion 7A and the lower side connected body containing portion 7B includes the multiple terminal-containing portions for containing the tab terminals 21, 31. Each of the terminal-containing portions is formed to be separated by a width-direction partition wall, not illustrated, separating the connected body containing portions 7A, 7B in the width direction Y. In each of the terminal-containing portions, the front side X1 and the rear side X2 are open, and the tab terminals 21, 31 are inserted through a rear side opening portion (not illustrated) on the rear side X2, while mating female terminals 11A that mate with the corresponding tab terminals 21, 31 are received through a front side opening portion (not illustrated) on the front side X1, so that the tab terminals 21, 31 and the female terminals 11A are electrically connected.

The lower wall 71B includes a lower wall body 710 opposing the upper wall 71A, a rear side extension wall 711 extending from the lower wall body 710 toward the rear side X2, and a lower side extension wall 712 continuous to the rear side extension wall 711 and formed to extend toward the lower side Z2. While the busbar 4 is contained in the housing 7, the rear side extension wall 711 is provided to oppose the first plate-shaped portion 51A of the busbar 4, and the lower side extension wall 712 is provided to oppose the second plate-shaped portion 51B of the busbar 4.

Furthermore, as illustrated in FIG. 3, the housing body 71 includes a pair of upper side support pieces 75, 75 and a pair of lower side support pieces 76, 76.

The upper side support pieces 75, 75 constituting the pair are provided between the housing side notch portions 73 explained later in the width direction Y. The upper side support pieces 75 are provided to protrude from the upper wall 71A to the lower side Z2, and with the busbar 4 being contained in the housing 7, the upper side support pieces 75 are configured to come into contact with the upper side base portion 20 of the upper side connected body 2 to press the upper side connected body 2 against the up-and-down partition wall 71D.

In the width direction Y, the pair of lower side support pieces 76, 76 are situated at the same positions are the pair of upper side support pieces 75, 75. The lower side support pieces 76 are provided to protrude from the up-and-down partition wall 71D toward the lower side Z2 and the rear side X2, and with the busbar 4 being contained in the housing 7, the lower side support pieces 76 are configured to come into contact with the lower side base portion 30 of the lower side connected body 3 and the first plate-shaped portion 51A to press the lower side connected body 3 against the lower wall 71B.

As illustrated in FIG. 3, with the busbar 4 being contained in the housing 7, the housing side jig insertion hole 72 is provided at a position in communication with the busbar side jig insertion hole 52. The housing side jig insertion hole 72 is formed such that the size of the housing side jig insertion hole 72 in the width direction Y is substantially the same size as the width size of the busbar side jig insertion hole 52.

As illustrated in FIG. 4, the housing side notch portion 73 is formed by cutting off the rear edge 71b of the housing body 71 (an edge on the opposite side from the press-in direction of the press-fit jig 8 into the connected body). As illustrated in FIG. 3, nine (multiple) housing side notch portions 73 are provided. The nine housing side notch portions 73 are provided such that three housing side notch portions 73 are provided on each of the upper wall 71A of the housing body 71, the lower wall body 710, and the up-and-down partition wall 71D. Each three housing side notch portions 73 are provided in the central portion and both end portions in the width direction Y of respective rear end faces of the upper wall 71A, the lower wall body 710, and the up-and-down partition wall 71D, and configured such that, with the busbar 4 being contained in the housing 7, the housing side notch portions 73 are cut out to such a degree that the jig contact surfaces 22, 32 of the busbar 4 are exposed. Because the housing side notch portions 73 are formed, the busbar 4 can be pressed into the front side X1 farther than the rear edge 71b of the housing body 71, and the amount of press-in of the busbar 4 into the housing body 71 can be measured. The housing side notch portions 73 provided on the upper wall 71A of the housing body 71 function as press-in amount measurement windows.

As illustrated in FIG. 5, the press-fit jig 8 includes three pressure portions 8A, 8B, and 8C. Each of the pressure portions 8A, 8B, and 8C include a pressure surface 8f capable of pressurizing the jig contact surfaces 22, 32 of the busbar 4. Each pressure surface 8f is constituted by a flat surface extending in the up-and-down direction Z and the width direction Y. Each pressure surface 8f is formed such that the size of each pressure surface 8f in the up-and-down direction Z is greater than the size of the upper side connected body 2 and the lower side connected body 3 in the opposing direction (the size in the up-and-down direction Z), so that the pressure surface 8f can press the jig contact surfaces 22, 32 of the upper side connected body 2 and the lower side connected body 3 simultaneously: The pressure portion 8B is formed such that the size of the pressure portion 8B in the width direction Y is smaller than the width size of the housing side jig insertion hole 72 and the busbar side jig insertion hole 52, so that, when the busbar side jig insertion hole 52 and the housing side jig insertion hole 72 are arranged to be in communication, the pressure portion 8B is insertable into the inside of the busbar side jig insertion hole 52 and the housing side jig insertion hole 72.

Next, a procedure for manufacturing the connector 1 using the press-fit jig 8 is explained with reference to FIGS. 4 to 6.

First, as illustrated in FIG. 4, the tips of the tab terminals 21, 31 of the busbar 4 are brought closer to and inserted into the rear side opening portions of the housing 7. As the busbar 4 is further inserted, the latch protrusions 211, 311 of the first tab terminals 21A, 31A of the connected bodies 2, 3 come into contact with the inner surfaces of the terminal-containing portions. Therefore, the pressure surface 8f of the pressure portion 8A of the press-fit jig 8 is brought closer to the jig contact surfaces 22A, 32A of the busbar 4, and the pressure surface 8f of the pressure portion 8C is brought closer to the jig contact surfaces 22C, 32C of the busbar 4. Also, the pressure portion 8B is inserted into the inside of the busbar side jig insertion hole 52 and the housing side jig insertion hole 72, so that the pressure surface 8f is brought closer to the jig contact surfaces 22B, 32B of the busbar 4.

Thereafter, the pressure portions 8A to 8C are moved simultaneously to press the busbar 4 against the inside of the housing 7. The pressure surface 8f of the pressure portion 8A of the press-fit jig 8 comes into contact with the jig contact surfaces 22A, 32A of the busbar 4, the pressure surface 8f of the pressure portion 8C of the press-fit jig 8 comes into contact with the jig contact surfaces 22C, 32C, and the pressure surface 8f of the pressure portion 8B of the press-fit jig 8 comes into contact with the jig contact surfaces 22B, 32B.

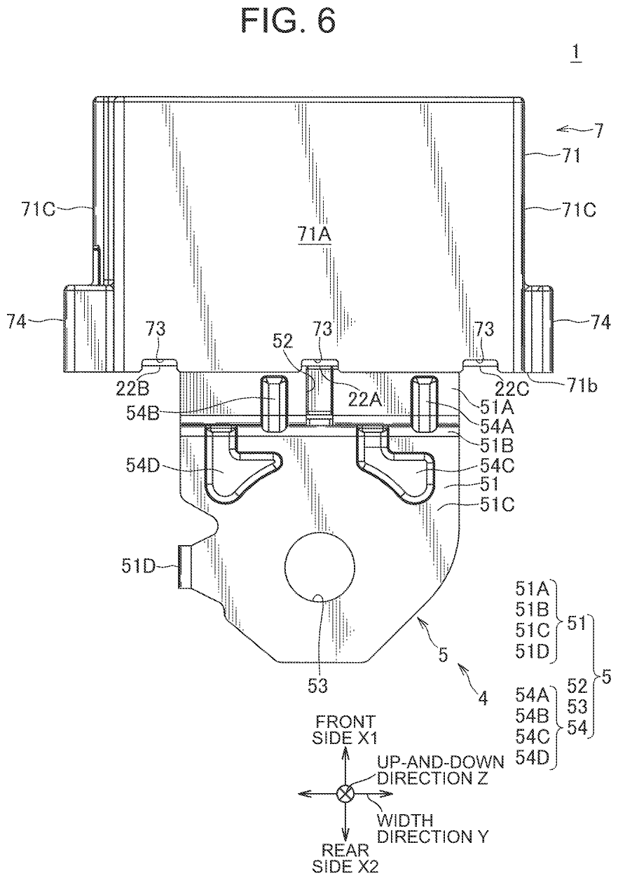

As illustrated in FIG. 5, as pressing of the pressure portions 8A to 8C further advances, the latch protrusions 211, 311 of the first tab terminals 21A, 31A of the connected bodies 2, 3 bite into the inner surfaces of the terminal-containing portions, so that the first tab terminals 21A, 31A latch to the inner surfaces of the terminal-containing portions. Accordingly, as illustrated in FIG. 6, the first tab terminals 21A, 31A reach predetermined positions in the respective terminal-containing portions to be contained in the respective terminal-containing portions, and the second tab terminals 21B, 31B reach predetermined positions in the respective terminal-containing portions to be contained in the respective terminal-containing portions. Also, the upper side connected body 2 is contained in the upper side connected body containing portion 7A, and the lower side connected body 3 is contained in the lower side connected body containing portion 7B.

In this case, although the press-in load for the first tab terminals 21A, 31A is high since the first tab terminals 21A, 31A are pressed in while the latch protrusions 211, 311 of the first tab terminals 21A, 31A bite into the inner surfaces of the terminal-containing portions, the jig contact surfaces 22A, 22B, 22C, 32A, 32B, 32C situated on the rear side X2 of the first tab terminals 21A, 31A are pressed by the pressure surface 8f of the press-fit jig 8, which decreases the press-in load for the first tab terminals 21A, 31A.

As illustrated in FIG. 6, while the first tab terminals 21A, 31A reach predetermined positions of the terminal-containing portions, the jig contact surfaces 22A, 22B, 22C, 32A, 32B, 32C are situated inside the housing side notch portions 73, so that they can be seen by a worker. Thus, the connector 1 is assembled.

Thereafter, the female terminals 11A of the terminal-attached electric wires 11 are inserted into the terminal-containing portions through the front side opening portions of the housing 7, so that in the terminal-containing portions, the tab terminals 21, 31 and the female terminals 11A are electrically connected.

Thereafter, the vehicle body fixation portion 5 of the busbar 4 is placed to oppose a predetermined position of a vehicle body panel. A stud bolt protruding from the vehicle body panel is inserted into the bolt insertion hole 53 of the busbar 4, and the fourth plate-shaped portion 51D of the vehicle body fixation portion 5 is inserted into a slit provided in the vehicle body panel. Thereafter, a nut, not illustrated, is fastened to the stud bolt, so that the vehicle body fixation portion 5 is fixed to the vehicle body panel. Thus, the connector 1 is fixed to the vehicle body panel. In this manner, with the connector 1 being fixed to the vehicle body panel, electric currents passing through the terminal-attached electric wires 11 are grounded to the vehicle body panel via the busbar 4.

According to the above-described embodiment, although the press-in load for the first tab terminals 21A, 31A is high since the first tab terminals 21A, 31A are pressed in while the latch protrusions 211, 311 of the first tab terminals 21A, 31A bite into the inner surfaces of the terminal-containing portions, the jig contact surfaces 22, 32 situated on the rear side X2 of the first tab terminals 21A, 31A are pressed by the pressure surface 8f of the press-fit jig 8, which decreases the press-in load for the first tab terminals 21A, 31A. Therefore, the first tab terminals 21A, 31A can be pressed in without warping, and deformation of the tab terminals 21, 31 can be alleviated. Furthermore, a contact margin in the front-and-back direction X between the tab terminals 21, 31 and the female terminal 11A can be sufficiently secured.

Furthermore, the jig contact surfaces 22, 32 are arranged in the central portion and both end portions in the width direction Y (arrangement direction) of the base portions 20, 30. Accordingly, a force is applied in a well-balanced manner in the width direction Y in each of the base portions 20, 30, and deformation of the tab terminals 21, 31 can be further alleviated.

Furthermore, the upper side base portion 20 is provided with the notch portions 20a, 20a that are formed by cutting off the rear end face 2b (an end face on the opposite side from the second tab terminal) of the upper side base portion 20, and the notch portions 20a, 20a are arranged at positions adjacent in the width direction Y (arrangement direction) to the jig contact surface 22 of the upper side connected body 2. Since the notch portions 20a are thus provided, the jig contact surfaces 22A, 22B, 22C (22) are provided to protrude with respect to the notch portions 20a, so that the jig contact surfaces 22A, 22B, 22C become distinguishable from other parts. Accordingly, the worker can recognize the jig contact surfaces 22A, 22B, 22C, so that the assembly work efficiency of the connector 1 is improved.

Furthermore, the housing body 71 includes the housing side notch portions 73 (press-in amount measurement windows), and is configured such that, with the tab terminals 21, 31 being contained in the terminal-containing portions, the jig contact surfaces 22, 32 are exposed from the housing side notch portions 73. Accordingly, since the housing side notch portions 73 are provided, the busbar 4 can be pushed into the deeper side (front side X1) farther than the rear edge 71b of the housing body 71, and the amount of press-in of the busbar 4 into the housing body 71 can be measured.

Furthermore, the connected bodies 2, 3 are provided to constitute a pair and arranged to oppose each other, the lower side connected body 3 (one of the connected bodies constituting the pair) includes the vehicle body fixation portion 5 fixed to the vehicle body panel, the vehicle body fixation portion 5 is provided with the busbar side jig insertion hole 52 (hole portion), and the jig contact surface 32B is provided on the inner surface of the busbar side jig insertion hole 52. Accordingly, even when the vehicle body fixation portion 5 is provided, the jig contact surface 32B can be provided, and therefore, the tab terminals 21, 31 can be pressed in without warping the tab terminals 21, 31. Note that the present invention is not limited to the embodiment, but includes other configurations that can achieve the object of the present invention, and the present invention also includes the following modifications.

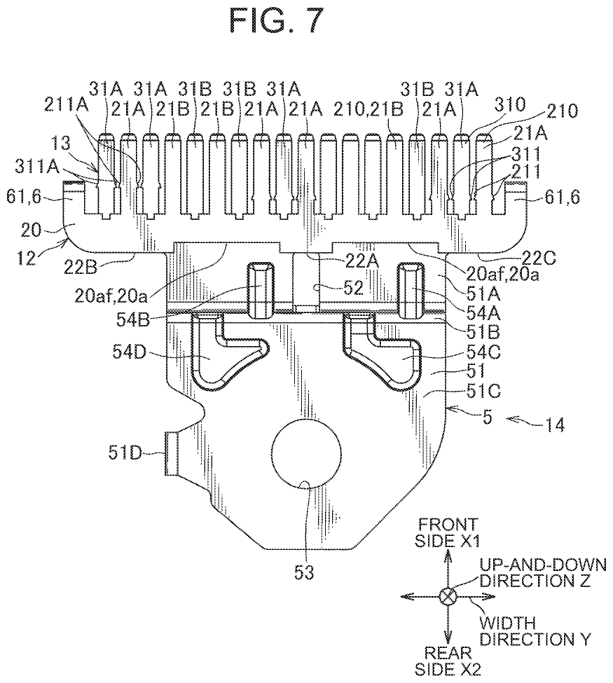

In the embodiment, the latch protrusions 211, 311 are provided at a position away from the base portions 20, 30 by a certain distance, but the present invention is not limited thereto. As illustrated in FIG. 7, in the busbar 14, the upper side connected body 12 may include latch protrusions 211 and latch protrusions 211A, and the lower side connected body 13 may include latch protrusions 311 and latch protrusions 311A. In this case, the positions where the latch protrusions 211A, 311A are formed may be farther from the base portion 20, 30 in the front-and-back direction X than the positions where the latch protrusions 211, 311 are formed. As illustrated in FIG. 7, the latch protrusions 211A, 311A may be provided in one of the end portions in the width direction Y, the other of the end portions in the width direction Y, or the central portion.

Although the best configuration, method, and the like for carrying out the present invention are disclosed in the above description, the present invention is not limited thereto. That is, although the present invention has been particularly illustrated and described primarily with respect to the particular embodiment, it is understood that, without departing from the spirit and scope of the present invention, the present invention can be modified in various ways by those skilled in the art in terms of shape, material, quantity, and other detailed configurations of the embodiment described above. Therefore, since the descriptions that limit the shape, material, and the like disclosed above are illustrative examples to facilitate understanding of the present invention, and do not limit the present invention, a description with a name of a member, from which some or all of the limitations on the shape, material, and the like are deleted, is to be included in the present invention.

### LIST OF REFERENCE SIGNS

1 connector
10 connector manufacturing apparatus
2,12 upper side connected body (connected body)
20 upper side base portion (base portion)
20a notch portion
21 upper side tab terminal (tab terminal)
21A upper side first tab terminal (first tab terminal)
21B upper side second tab terminal (second tab terminal)
211, 211A upper side latch protrusion (latch protrusion)
22 upper side jig contact surface (jig contact surface)
3, 13 lower side connected body (connected body, one of the connected bodies constituting the pair)
30 lower side base portion (base portion)
31 lower side tab terminal (tab terminal)
31A lower side first tab terminal (first tab terminal)
31B lower side second tab terminal (second tab terminal)
311, 311A lower side latch protrusion (latch protrusion)
32 lower side jig contact surface (jig contact surface)
5 vehicle body fixation portion
52 busbar side jig insertion hole (hole portion)
7 housing
71 housing body
73 housing side notch portion (press-in amount measurement window)
8 press-fit jig
Y width direction (direction in which first tab terminals and second tab terminals are arranged)

What is claimed is:

1. A connector manufacturing apparatus for manufacturing a connector that includes:
a connected body including tab terminals; and
a housing including a housing body in a tubular shape containing the connected body and terminal-containing portions provided in the housing body to contain the respective tab terminals,
wherein the connector manufacturing apparatus comprises a press-fit jig for pressing the connected body into the housing to contain the tab terminals in the terminal-containing portions, wherein the tab terminals include:
first tab terminals that include latch protrusions capable of biting into inner surfaces of the terminal-containing portions to latch to the terminal-containing portions; and
second tab terminals that do not include the latch protrusions,
the connected body is provided with a jig contact surface on an end face on an opposite side from the first tab terminals, the jig contact surface being formed for the press-fit jig to come into contact therewith.

2. The connector manufacturing apparatus according to claim 1, wherein the first tab terminals and the second tab terminals are arranged side by side,
the connected body includes a base portion on which the first tab terminals and the second tab terminals are arranged continuously, the base portion being formed to extend in a direction in which the first tab terminals and the second tab terminals are arranged side by side, and
the jig contact surface is provided in a central portion and both end portions, in the direction in which the first tab terminals and the second tab terminals are arranged side by side, of the base portion.

3. The connector manufacturing apparatus according to claim 2, wherein the base portion is provided with a notch portion that is formed by cutting off an end face on an opposite side from the second tab terminals, and
the notch portion is provided at a position adjacent to the jig contact surface in the direction in which the first tab terminals and the second tab terminals are arranged side by side.

4. The connector manufacturing apparatus according to claim 1, wherein the housing body includes a press-in amount measurement window that is formed by cutting off an edge on an opposite side from a press-in direction of the press-fit jig into the connected body,
with the tab terminals being contained in the terminal-containing portions, the jig contact surface is configured to be exposed from the press-in amount measurement window.

5. The connector manufacturing apparatus according to claim 2, wherein a pair of connected bodies is provided such the connected bodies constituting the pair oppose each other,
one of the connected bodies constituting the pair includes a vehicle body fixation portion that is continuous to the base portion and that extends in a direction away from the tab terminals to be fixed to a vehicle body panel,
the vehicle body fixation portion is provided with a hole portion through which the press-fit jig is inserted,
the jig contact surface is provided on an inner surface of the hole portion.
